(19) United States
(12) Patent Application Publication
(10) Pub. No.: US 2002/0087996 A1
(43) Pub. Date: Jul. 4, 2002

(54) Interactive remote control of audio or video playback and selections

(76) Inventors: Depeng Bi, Algonquin, IL (US); Stephen Christopher Gladwin, Chicago, IL (US); Troy Steven Denkinger, Chicago, IL (US); Jeffrey Jonathan Spurgat, Madison, WI (US); Hoyet Harrison Andrews III, San Antonio, TX (US)

Correspondence Address: KATTEN MUCHIN ZAVIS, Attention: Patent Administrator, Suite 1600, 525 West Monroe Street, Chicago, IL, 60661-3693, US

(21) Appl. No.: 09/994,011

(22) Filed: Nov. 6, 2001

Related U.S. Application Data
(60) Provisional application No. 60/246,923, filed on Nov. 10, 2000.

(51) Int. Cl. H04N 7/173

(52) U.S. Cl. 725/89; 725/109; 725/123; 725/134

(57) ABSTRACT

A system for an interactive remote control wired or wireless, of an audio or video playback application running on a personal computer or other computing platform. This interactive control includes playback of current audio or video content or selection of new audio or video content or lists of content for playback. The wireless interactive remote control device, or navigator, may contain an audio or video browser for simplifying interactive control by integrating control of a variety of content, for example, music, video, and Internet radio, independent of whether this content exists locally on the computing platform or is accessed over the Internet or some other computer network.

### CROSS-REFERENCE TO RELATED APPLICATIONS

This application claims priority of U.S. patent application Ser. No. 60/246,923 filed on Nov. 10, 2000. This application is related to co-pending commonly-owned patent applications: Ser. No. 09/649,981, filed on Aug. 29, 2001 and Ser. No. 09/709,772, filed on Nov. 8, 2000, both entitled: “Structure and Method for Selecting, Controlling and Sending Internet-Based or Local Digital Audio to an AM/FM Radio or Analog Amplifier”; “Digital Content Distribution and Subscription File Subscription System,” filed on even date; and “Content Protection Through Audio and Video Decrypting and Decoding Device,” Ser. No. 09/883,173, filed on Apr. 11, 2001, all hereby incorporated by reference.

### BACKGROUND OF THE INVENTION

1. Field of the Invention

The present invention relates to interactive control of audio or video playback and selection of digital content running on a personal computer or other computing platform.

2. Description of the Prior Art

There is an ever-increasing amount of digital content available, for example, digital audio files, for example, in MP3 format, like those found at www.mp3.com or as streaming digital audio, such as using the streaming digital audio techniques described in U.S. Pat. No. 5,579,430. These new types of audio content can be played on a personal computer with a sound card, but cannot be played on a radio or stereo that is designed to receive and amplify analog audio signals.

Several techniques are known for converting a digital audio source to an analog signal for use by an analog radio or amplifier. However, such techniques are known to interfere with the operation of a host PC and thus require use of the PC to select and control the audio, for example, on an analog radio. Thus, there is a need to provide a system which enables digital content, such as Internet-based or digital audio to be played, for example, on an analog radio without tying up a personal computer.

### SUMMARY OF THE INVENTION

Briefly, the present invention and method involves interactive remote control, either wired or wireless, of an audio or video playback application running on a personal computer or other computing platform. The interactive remote control provides various functions, such as playback of current digital audio or video content; selection of new audio or video content; and providing lists of content for playback. The wireless interactive control device may contain an audio or video browser for simplifying interactive control, by integrating control of a variety content, such as music, video, and Internet radio, independent of whether this content exists locally on the computing platform or is accessed over the Internet or some other computer network. An important aspect of this invention is that the digital content can be controlled from a location away from the computing platform running the digital content playback application.

### DESCRIPTION OF THE DRAWINGS

These and other advantages of the present invention will be readily apparent from the following description and attached drawing where:

FIG. 1 is a block diagram that provides an overview of a system for interactive remote control of audio or video playback and selection in accordance with the present invention.

FIG. 2 is a block diagram of the system architecture for interactive remote control of audio or video playback and selection using local playback of audio or video in accordance with the present invention.

FIG. 3 is a block diagram of the system architecture for interactive remote control of audio or video playback and selection using transmitted playback of audio or video in accordance with the present invention.

FIG. 4 is a block diagram of a computing platform in accordance with the present invention.

FIG. 5 is a block diagram of the architecture of a remote control device or navigator in accordance with the present invention.

FIG. 6 is a software flow diagram for audio or video playback on the computing platform as part of a system for interactive remote control of audio or video playback and selection in accordance with the present invention.

FIG. 7 is a software flow diagram for navigator control management on the computing platform as part of a system for interactive remote control of audio or video playback and selection in accordance with the present invention.

FIG. 8 is a software flow diagram for interface and control handling on the navigator as part of a system for interactive remote control of audio or video playback and selection in accordance with the present invention.

FIGS. 9-13 are schematic diagrams of the navigator as part of a system for interactive remote control of audio or video playback and selection in accordance with the present invention.

### DETAILED DESCRIPTION

### System Overview

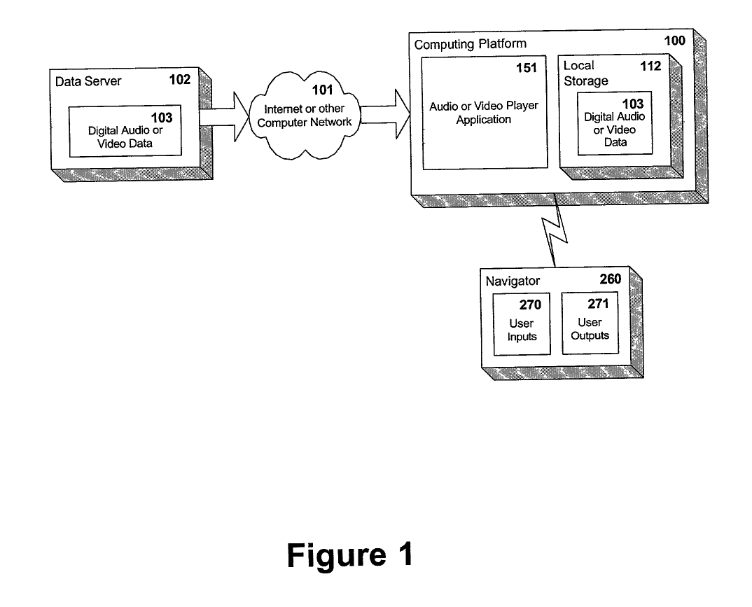

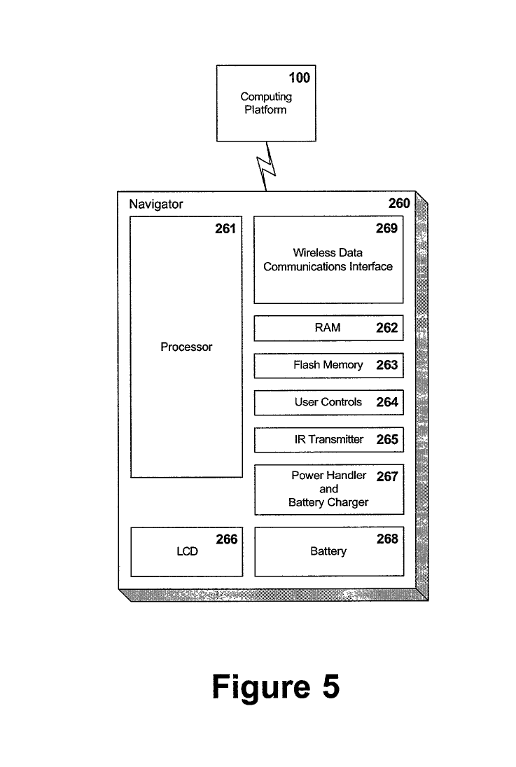

The present invention relates to interactive control of digital content, such as digital audio or video content, running on a computing platform, such as a personal computer, set top box or other device, such as personal digital assistant. The interactive remote control device 260 (FIG. 1), also referred to as the navigator 260, is described in more detail below in connection with FIG. 5. This device 260 communicates with an audio or video player application 151 (FIG. 1) running on a computing platform 100, such as a personal computer, set-top box, or Internet appliance. This communication can be handled in a conventional manner and may be either wired or wireless. The navigator 260 is used to send user inputs 270 from user controls 264 (FIG. 5) on the navigator 260, such as buttons, dials, a touch screen, and a keyboard, to the audio or video player application 151 (FIG. 1) running on the computing platform 100. The navigator 260 may be configured to display user outputs 271, such as graphics and text for display on an LCD 266 (FIG. 5) or control of LEDs, from the audio or video player application 151 running on the computing platform 100. The audio or video player application 151 (FIG. 1) is configured to receive digital audio or video data 103 from local storage device 112 on the computing platform 100 or from a data server 102 connected to the computing platform 100 by the Internet or other computer network 101.

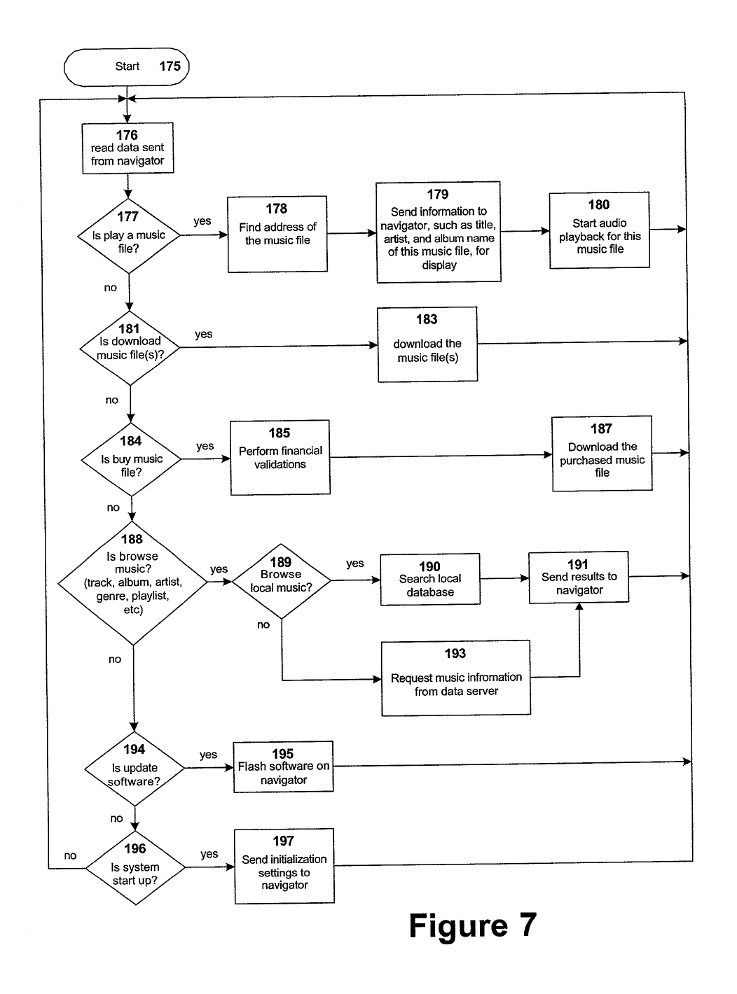

The interpretation and translation of the user inputs 270 from the navigator 260 and user outputs 271 to the navigator 260 are handled primarily by a navigator control manager 154, described later in more detail below in connection with FIG. 7, that runs on the computing platform 100. The navigator control manager 154 may be part of the audio or video player application 151 or exist independently.

### Local Playback System Architecture

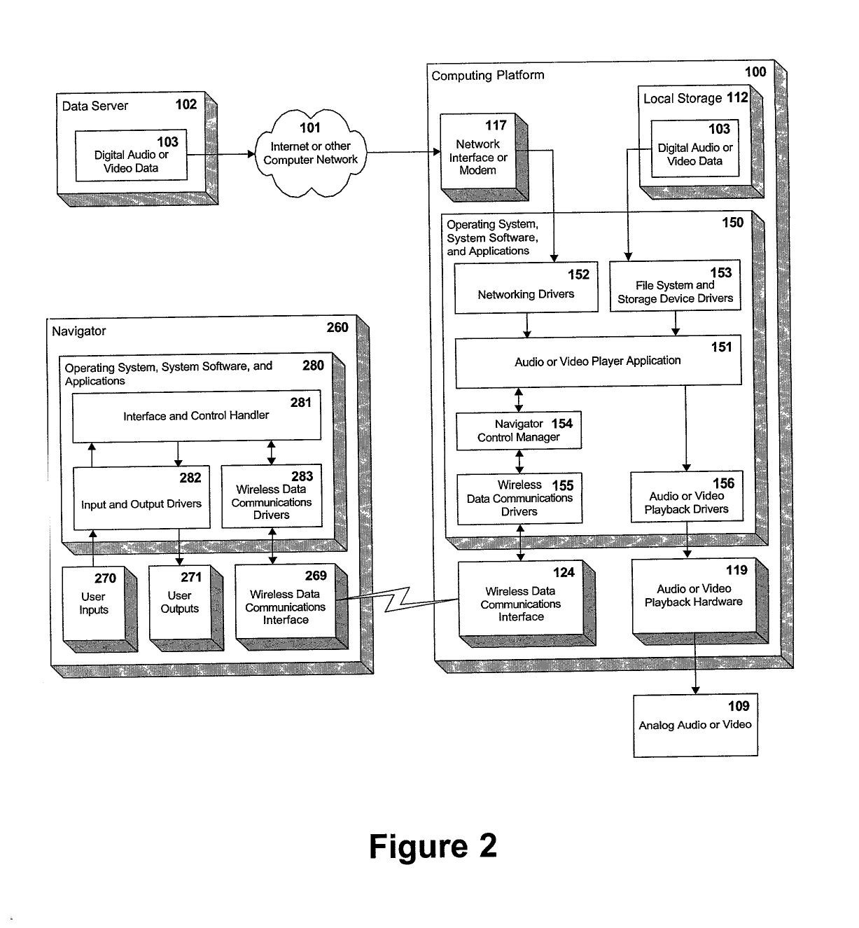

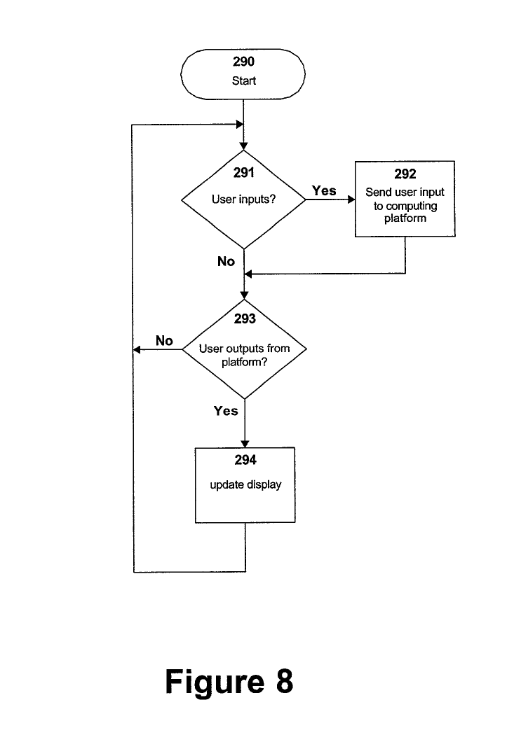

There are various configurations for remote control of audio or video playback and selection. An exemplary embodiment is illustrated in FIG. 2. In this embodiment, the audio or video player application 151, running on the computing platform 100, receives digital audio or video data 103 from the local storage device 112 on the computing platform 100. Access to the local storage device 112 by the audio or video player application 151 is handled through the file system and the storage device drivers 153, conventionally part of the operating system for the computing platform 100. The audio or video player application 151 can also receive digital audio or video data 103 from a data server 102 connected to the computing platform 100 through the Internet or other computer network 101. Access to the network interface or modem 117 by the audio or video player application 151 is handled though networking drivers 152, also part of the operating system for the computing platform 100. The audio or video player application 151 running on the computing platform 100 may interact with the navigator 260 through a wireless data communications interface 124 on the computing platform 100. This wireless data communications interface 124 can be, for example, Bluetooth, HomeRF, IEEE 802.11, or an infrared interface. Access to the wireless data communications interface 124 on the computing platform 100 may be handled through, for example, conventional wireless data communications drivers 155. On the computing platform 100, the navigator control manager 154, discussed in detail in connection with FIG. 7, interprets and translates the user inputs 270 from the navigator 260 into commands for control of the audio or video player application 151 running on the computing platform 100. The navigator control manager 154, running on the computing platform 100, takes information from the audio or video player application 151 and generates user outputs 271 for the navigator 260. On the navigator 260, communication with the navigator control manager 154 running on the computing platform 100 is handled through a wireless data communications interface 269 on the navigator 260. This wireless data communications interface 269 must be compatible with the wireless data communications interface 124 on the computing platform 100. Access to the wireless data communications interface 269 on the navigator 260 is handled through wireless data communications drivers 283. The wireless communication interfaces 124 and 269 may be standard interfaces, such as Home RF, IEEE 802.11 or Bluetooth. The communication drivers 283 may be the standard drivers for the communication interfaces discussed above. Alternative embodiments of the wireless data communication interfaces 124 and 269 as well as the wireless communications driver 283 are disclosed in commonly-owned co-pending patent application Ser. No. 09/649,981, hereby incorporated by reference. The interface and control handler 281, discussed in detail in connection with FIG. 8, running on the navigator 260 takes user inputs 270 from user controls 264, such as buttons, dials, and touch screens, and passes these user inputs 270 through the wireless data communications interface 269 to the navigator control manager 154 running on the computing platform 100. As well, the interface and control handler 281 running on the navigator 260 receives user outputs 271 from the navigator control manager 154 running on the computing platform 100 through the wireless data communications interface 269. The interface and control handler 281 then passes these user outputs 271 to the appropriate user output devices, such as a graphics display on an LCD 266 or the LEDs. Access to user inputs 270 and user outputs 271 is handled through input and output drivers 282 on the navigator 260.

The audio or video player application 151 running on the computing platform 100 passes the digital audio or video data 103 to the audio or video playback hardware 119 on the computing platform 100, using the audio or video playback drivers 156 to communication with the audio or video playback hardware 119. The audio or video playback hardware 119 converts the digital audio or video data 103 to analog audio or video 109, which can then be connected to a stereo or headphones for listening or to a TV for viewing.

Software components running on the computing platform 100 are contained within the operating system, system software, and applications 150. Similarly, software and firmware components running on the navigator 260 are contained within the operating system, system software, and applications 280.

### Transmitted Playback System Architecture

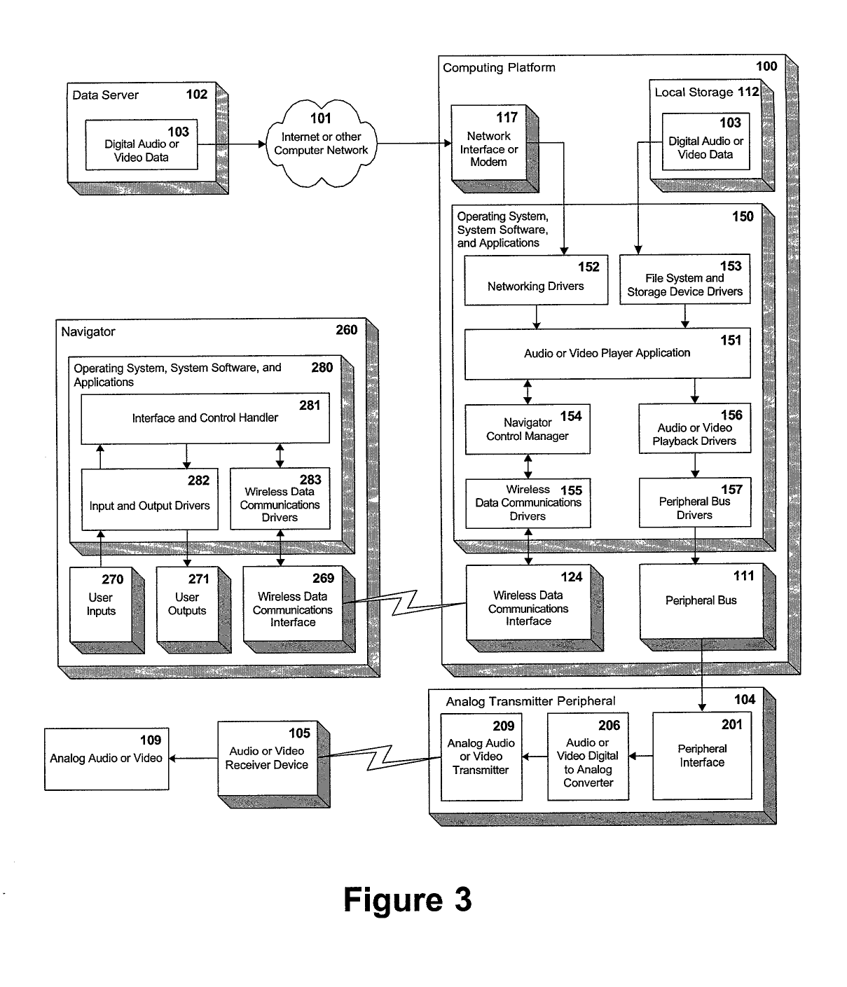

Various alternate embodiments of remote control of audio or video playback and selection are contemplated. One such embodiment is illustrated in FIG. 2 of commonly-owned co-pending patent application Ser. No. ______, filed on even date, entitled “Digital Audio and Video Distribution Transmission and Playback System,” (Attorney Docket No. 11748/13 PCT), hereby incorporated by reference. Another embodiment is illustrated in FIG. 3. As in the previous configuration shown in FIG. 2, the audio or video player application 151 running on the computing platform 100 can receive digital audio or video data 103 from the local storage device 112 on the computing platform 100. Access to local storage 112 device by the audio or video player application 151 is handled through file system and storage device drivers 153. The audio or video player application 151 can also receive digital audio or video data 103 from a data server 102 connected to the computing platform 100 through the Internet or other computer network 101. Access to the network interface or modem 117 by the audio or video player application 151 is handled though networking drivers 152. The audio or video player application 151 running on the computing platform 100 interacts with the navigator 260 through a wireless data communications interface 124 on the computing platform 100. This wireless data communications interface can be, for example, Bluetooth, HomeRF, IEEE 802.11, or an infrared interface. Access to the wireless data communications interface 124 on the computing platform 100 is handled through the wireless data communications drivers 155. On the computing platform 100, the navigator control manager 154 interprets and translates the user inputs 270 from the navigator 260 into commands for and control of the audio or video player application 151 running on the computing platform 100. The navigator control manager 154 running on the computing platform 100 also takes information from the audio or video player application 151 and generates user outputs 271 for the navigator 260. On the navigator 260, communication with the navigator control manager 154 running on the computing platform 100 is handled through a wireless data communications interface 269 on the navigator 260. This wireless data communications interface 269 must be compatible with the wireless data communications interface 124 on the computing platform 100. Access to the wireless data communications interface 269 on the navigator 260 is handled through wireless data communications drivers 283. The interface and control handler 281 running on the navigator 260 takes user inputs 270 from user controls 264, such as buttons, dials, and touch screens, and passes these user inputs 270 through the wireless data communications interface 269 to the navigator control manager 154 running on the computing platform 100. As well, the interface and control handler 281 running on the navigator 260 receives user outputs 271 from the navigator control manager 154 running on the computing platform 100 through the wireless data communications interface 269. The interface and control handler 281 then passes these user outputs 271 to the appropriate user output device, such as a graphics display on an LCD 266 or LEDs. Access to user inputs 270 and user outputs 271 is handled through input and output drivers 282 on the navigator 260.

However, unlike the previous configuration described in FIG. 2, where the computing platform 100 generates an analog audio or video data 109 for input to an analog device, in the configuration shown in FIG. 3, the digital audio or video data 103 is passed by the audio or video player application 151 running on the computing platform 100 to an analog transmitter peripheral 104. The audio or video player application 151 uses audio or video playback drivers 156 and peripheral bus drivers 157 to communicate with the analog transmitter peripheral 104 through the peripheral bus 111 on the computing platform 100. The analog transmitter peripheral 104 receives the digital audio or video data 103 through a peripheral interface 201 on the analog transmitter peripheral 104. The digital audio or video data 103 is then converted to analog audio or video 109 by the audio or video digital to analog converter 206 on the analog transmitter peripheral 104. The analog audio or video 109 is transmitted by an analog audio or video transmitter 209 on the analog transmitter peripheral 104 to an audio or video receiver device 105 that makes the analog audio or video 109 available for listening, such as on a stereo or headphones, or viewing such as on a TV.

Software components including the various drivers discussed above, running on the computing platform 100 are contained within the operating system, system software, and applications 150. Similarly, software and firmware components running on the navigator 260 are contained within the operating system, system software, and applications 280.

It should be noted that the embodiments described (FIGS. 2 and 3) represent only two of a plethora of possible embodiments for configurations of a system for interactive remote control of audio or video playback and selection.

### Computing Platform

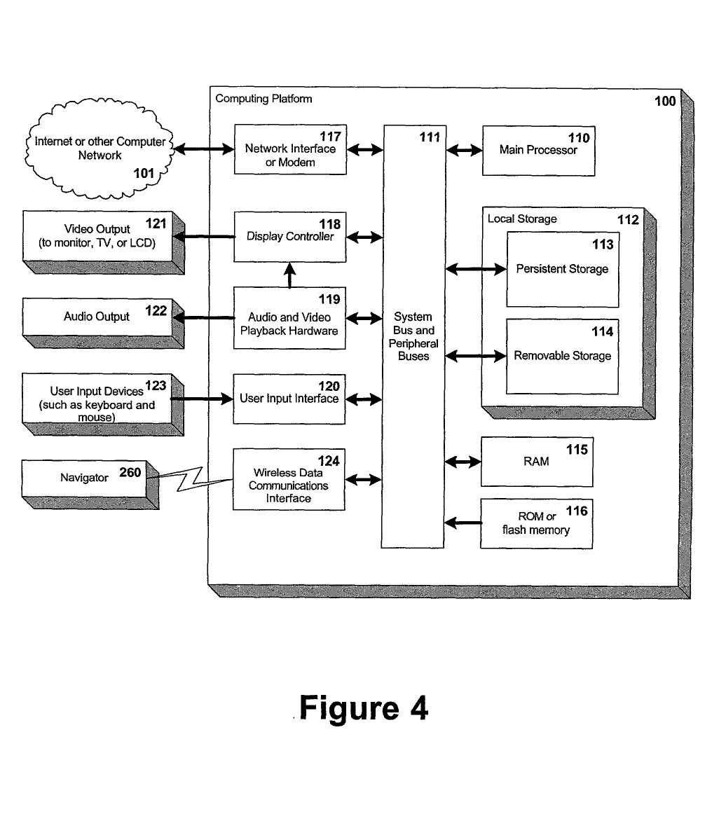

FIG. 4 illustrates an exemplary system architecture for the computing platform 100, which can encompass anything from general-purpose devices, such as a personal computer, to open fixed function devices, such as a set-top box that connects to a television set. However, the computing platform 100 is not restricted to these examples. In general, the computing platform 100 includes a main processor 110, for example, an Intel Pentium III or better, for executing various software components. The various software components are typically stored in read only memory, or ROM, or flash memory 116, or the local storage device 112. The local storage device 112 can consist of persistent storage 113, such as hard drives or flash memory, or removable storage 114, such as floppy drives, CD-ROM drives, or DVD drives. The software components are executed by the main processor 110 directly from their storage location or may be loaded into random access memory or RAM 115, to be executed from RAM 115 by the main processor 110. The computing platform 100 uses a network interface or modem 117 to access data server computers 102 on the Internet or other computer network 101, in order to download digital audio or video data 103. The network interface or modem 117 is connected internally or externally to the computing platform 100 using a system bus or peripheral bus 111. The system bus and peripheral buses 111 are provided for connecting internal and external devices to the computing platform 100 in a standard manner. Typical system and peripheral buses 111 include Universal Serial Bus, commonly referred to as USB, IEEE 1394, commonly referred to as FireWire, and Peripheral Connect Interface, commonly referred to as PCI. The computing platform 100 may also support connection through a user input interface 120 to external or integrated user input devices 123, such as a keyboard and mouse. For output to the user, the computing platform 100 may contain a display controller 118, for example, an NVIDIA model GeForce2, which stores graphical data, such as windows, bitmaps and text. The display controller 118 outputs the graphical data as video output 121 that is typically displayed to the user on a video monitor, television, or LCD panel. In addition to video output 121, the computing platform 100 may provide audio output 122, which is handled by the audio and video playback hardware 119, which also provides support for video playback to the display controller 118. It should be noted that a client computing platform 100 is not limited to the capabilities and features listed in this description, but may contain a subset of the described features or may contain additional capabilities or features not listed.

### Navigator Architecture

The navigator 260 (FIG. 5) acts as a remote control and allows the user to receive feedback from and provide input to an audio or video player application 151 running on a computing platform 100. In the embodiment shown, the computing platform 100 wirelessly transmits and receives data communications with the navigator 260, giving the navigator 260 functionality within the range of the wireless communications. The navigator 260 receives and transmits the data communications using the wireless data communications interface 269. This wireless data communications interface 269 may be, for example, a Bluetooth, HomeRF, or IEEE 802.11 interface. This wireless data communications interface 269 must match the technology chosen for use on the computing platform 100. The processor 261 handles the data communications with the wireless data communications interface 269. The processor 261 also takes user inputs 270 from the user controls 264, which are typically buttons and dials, and sends this information to the wireless data communications interface 269 for wireless transmission to the computing platform 100 and eventually back to the audio or video player application 151 running on the computing platform 100. The processor 261 receives update information from the audio or video player application 151 through the wireless data communications interface 269, which the processor 261 then makes available to the user by updating the graphic information on the liquid crystal display panel, or LCD 266. The processor 261 reads the code it runs from the flash memory 263, which is also used to store information that must survive power cycling of the navigator 260. The processor 261 uses random access memory, or RAM 262, for executing code and storing volatile information, this is information that is subject to change or does not need to survive power cycling of the navigator 260.

Additional functionality may be provided through the power handler and battery charger 267, controlled by the processor 261 and responsible for handling power management, conserving battery life, and charging of the battery 268. There is also an infrared or IR transmitter 265 that allows the navigator 260 to control audio playback equipment, such as a stereo.

### Audio or Video Playback Handler

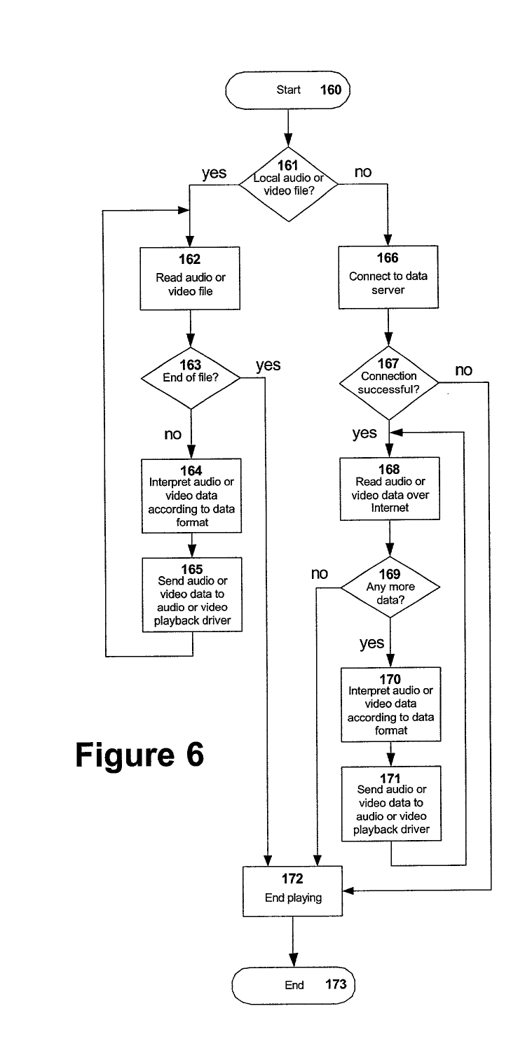

FIG. 6 is a software flow diagram for audio or video playback on the computing platform 100, which in the example described henceforth, is called the audio or video playback handler. The audio or video playback handler is called as part of the audio or video player application 151 to playback the digital audio or video data 103. “Start” in step 160 represents the beginning of the audio or video playback handler. The audio or video playback handler receives the audio or video playback selection when it is called. The audio or video playback handler checks if the audio or video playback selection is available locally on the computing platform 100 in step 161. If the file is available locally, the audio or video playback handler reads the digital audio or video data 103 from the audio or video file in step 162. Next, the audio or video playback handler checks if it is at the end of the audio or video file to playback in step 163. If it is at the end of the audio or video file, then the audio or video playback handler ends playing of the audio or video file in step 172 and the audio or video playback handler ends in step 173. If not, at the end of the audio or video file in step 163, then the audio or video playback handler takes this digital audio or video data 103 and interprets the data according to the data format in step 164. The audio or video playback handler then sends the interpreted digital audio or video data in step 165 to the audio or video playback drivers 156, which handle conversion of the digital audio or video data 103 to analog audio or data video 109 using the audio or video playback hardware 119. The audio or video playback handler reads digital audio or video data 103 from the audio or video file in step 162 again. If the audio or video file is not available locally in step 161, then the audio or video playback handler connects to the data server 102 on the Internet or other computer network 101 in step 166. If the connection is not successful in step 167, then the audio or video playback handler ends playing of the audio or video file in step 172 and the audio or video playback handler ends in step 173. If the connection is successful in step 167, then the audio or video playback handler reads the digital audio or video data 103 from the data server 102 over the Internet or other computer network 101 in step 168. Next, the audio or video playback handler checks if there is more digital audio or video data to read for playback in step 169. If there is no more digital audio or video data 103 to read, then the audio or video playback handler ends playing of the audio or video data 103 in step 172 and the audio or video playback handler ends in step 173. If there is more digital audio or video data 103 to read for playback in step 169, then the audio or video playback handler takes this digital audio or video data 103 and interprets the data according to the data format in step 170. The audio or video playback handler then sends the interpreted digital audio or video data in step 171 to the audio or video playback drivers 156, which handles conversion of the digital audio or video data 103 to analog audio or video 109 using the audio or video playback hardware 119. Then the audio or video playback handler reads digital audio or video data 103 from the data server 102 over the Internet or other computer network 101 in step 168 again.

### Navigator Control Manager

The navigator control manager 154, which runs on the computing platform 100, takes the user inputs 270, such as button presses, from the navigator 260 and interprets and translates them into commands and actions for the audio or video player application 151. The navigator control manager 154 then takes the results from the commands and actions of the audio or video player application 151 to provide user outputs 271 on the navigator 260, such as updated graphics on an LCD 266 on the navigator 260. FIG. 7 provides the software flow of the navigator control manager 154. In this example, the navigator control manager 154 is a continuously running process on the computing platform 100 and operates with an audio player application 151 and a navigator 260 with graphical output capabilities and operates as part of interactive remote control specifically for digital music playback and selection.

“Start” in step 175 represents the beginning of the navigator control manager 154. Next, the navigator control manager 154 reads any data sent from the interface and control handler 281 on the navigator 260 in step 176. If there is a play music file command from the navigator 260 in step 177, then the navigator control manager 154 finds the address of the music file in step 178. Next, the navigator control manager 154 sends user output information to the navigator 260 in step 179, such as the music title, the artist, and the album name, for display to the user. The navigator control manager 154 then starts the audio playback handler, described previously (FIG. 6), to playback the music file in step 180 and the navigator control manager 154 reads any data sent from the interface and control handler 281 on the navigator 260 in step 176 again. If there is not a play music file command in step 177, and if there is a download music file or files command from the navigator 260 in step 181, then the navigator control manager 154 downloads the music file or files in step 183. Then the navigator control manager 154 reads any data sent from the interface and control handler 281 on the navigator 260 in step 176 again. If there is not a download music file or files command in step 181 and if there is a buy music file command from the navigator 260 in step 184, then the navigator control manager 154 performs any financial validations required to complete the purchase of the music file in step 185. Next, the navigator control manager 154 downloads the purchased music file in step 187 and the navigator control manager 154 reads any data sent from the interface and control handler 281 on the navigator 260 in step 176 again. If there is not a buy music file command in step 184 and if there is a browse music command from the navigator 260 in step 188, then the navigator control manager 154 checks if the music to browse is local to the computing platform 100 in step 189. If the music to browse is local to the computing platform 100, then the navigator control manager 154 searches the local database in step 190 and sends the results of the local music browse to the navigator 260 in step 191. Then the navigator control manager 154 reads any data sent from the interface and control handler 281 on the navigator 260 in step 176 again. If the music to browse is not local to the computing platform 100, then the navigator control manager 154 requests music information from the data server 102 in step 193 and sends the results of the local music browse to the navigator 260 in step 191. Then the navigator control manager 154 reads any data sent from the interface and control handler 281 on the navigator 260 in step 176 again. Typically, a browse of music is based on such criteria as music track, album, artist, music genre, and playlists. If there is not a browse music command in step 188 and if there is an update software command from the navigator 260 in step 194, then the navigator control manager 154 updates the system software stored in flash memory 263 on the navigator 260 and the navigator control manager 154 reads any data sent from the interface and control handler 281 on the navigator 260 in step 176 again. This software update includes the interface and control handler 281 on the navigator 260. If there is not an update software command in step 194 and if there is a system start up command from the navigator 260 in step 196, then the navigator control manager 154 sends initialization settings to the navigator 260 in step 197 and the navigator control manager 154 reads any data sent from the interface and control handler 281 on the navigator 260 in step 176 again.

### Interface and Control Handler

The interface and control handler 281, which runs on the navigator 260, takes the user inputs 270, such as button presses, and sends them to the navigator control manager 154 running on the computing platform 100. The interface and control handler 281 also receives user outputs 271 from the navigator control manager 154 such as updated graphics on an LCD 266 on the navigator 260. FIG. 8 provides the software flow of the interface and control handler 281. In this example, the interface and control handler 281 is a continuously running process on the navigator 260 and provides user outputs 271 in a graphical display on an LCD 266 on the navigator 260.

“Start” in step 290 represents the beginning of the interface and control handler 281. If there are user inputs 270 from the user controls 264 on the navigator 260 in step 291, then the interface and control handler 281 sends the user inputs 270 to the navigator control manager 154 running on the computing platform 100 in step 292. If there are no user inputs 270 in step 291 or the user inputs 270 have been sent in step 292, then the interface and control handler 281 checks if there are user outputs 271 from the navigator control manager 154 running on the computing platform 100 in step 293. If there are user outputs 271 from the navigator control manager 154, then the interface and control handler 281 takes the user outputs 271 and updates the graphics displayed on the LCD 266 in step 294. After the display has been updated in step 294 or if there are no user outputs 271 in step 293 then the interface and control handler 281 checks for user inputs in step 291 again.

### Navigator Schematics

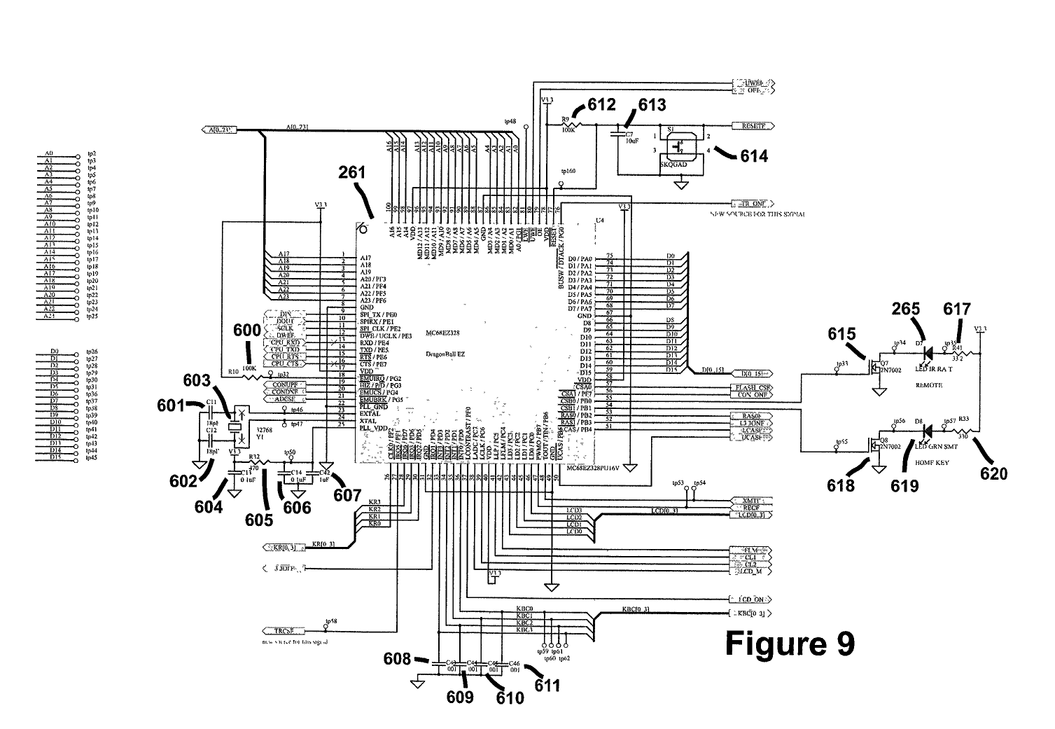

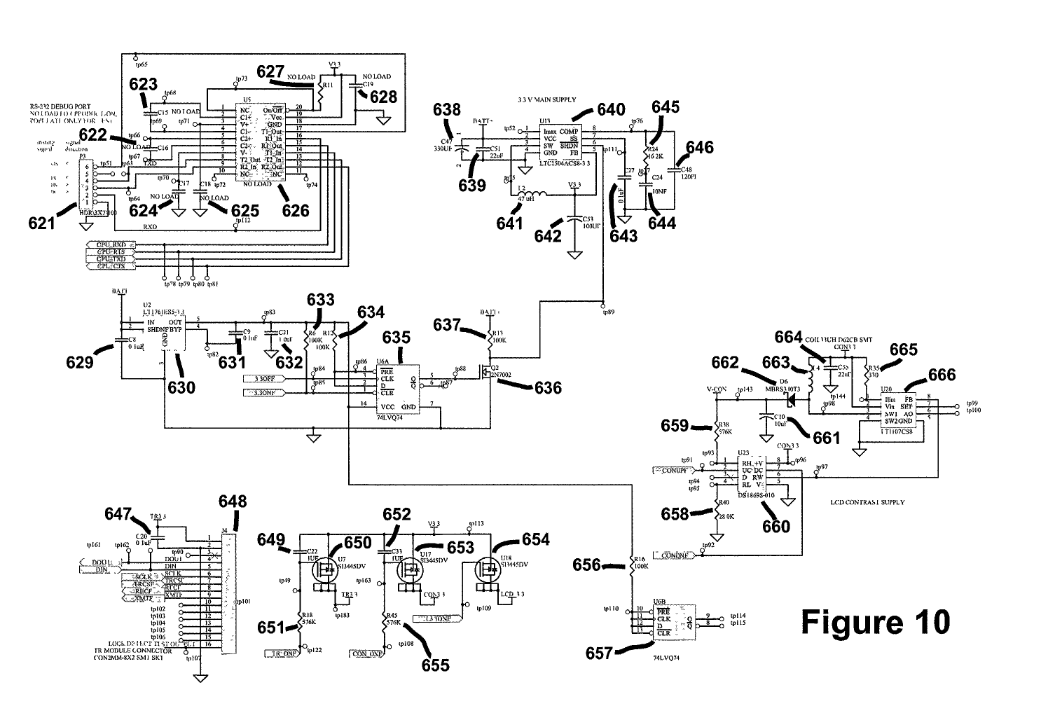

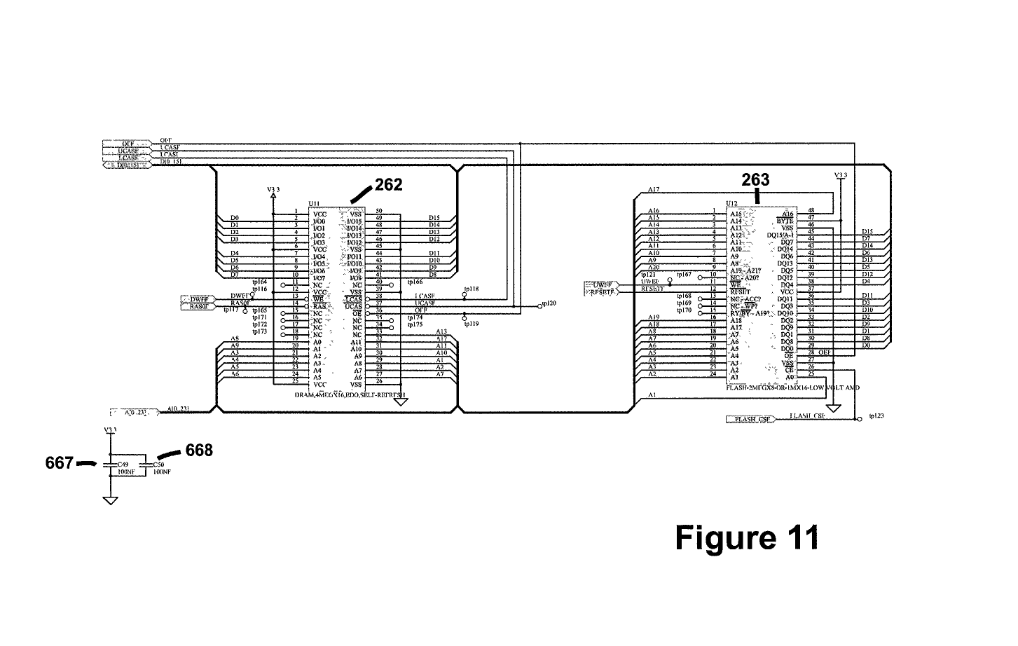

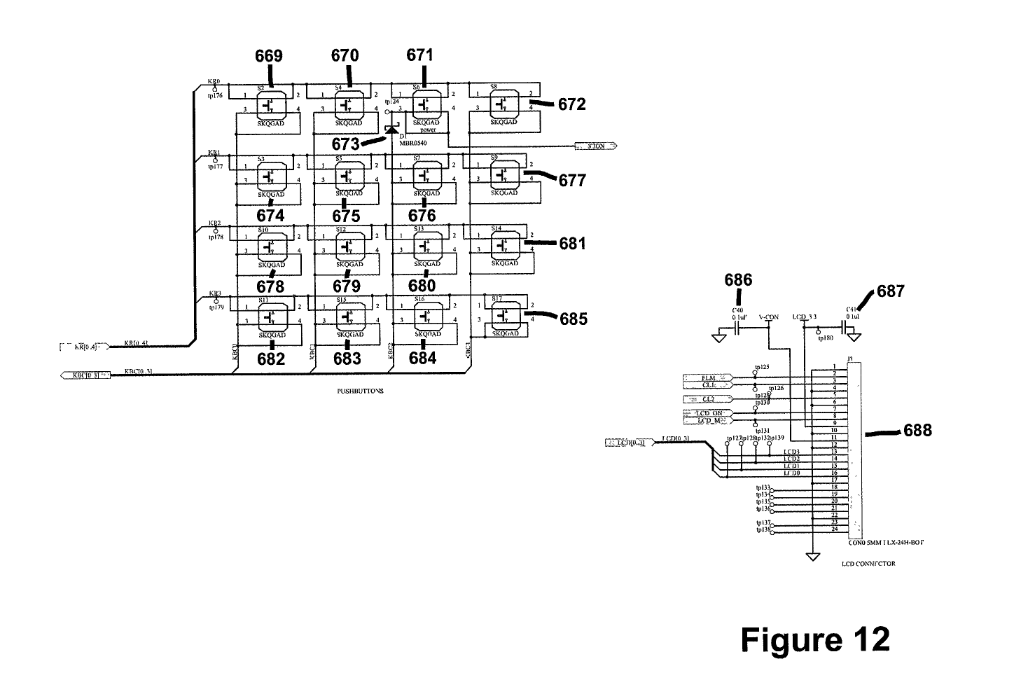

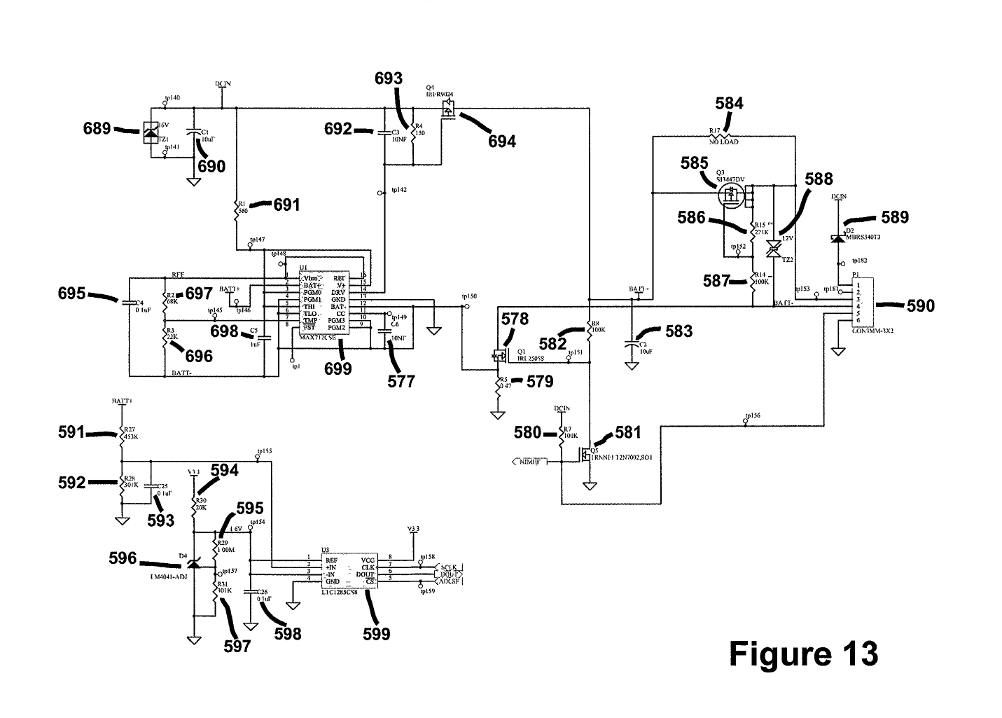

FIGS. 9-13 represent the schematic design for an exemplary embodiment of the navigator 260. The wireless data communication interface 269 module connects both electrically and mechanically to the navigator 260 using the connector 648 on the navigator 260. Capacitor 647 on the navigator 260 provides additional filtering on the power supplied to the wireless data communication interface 269 module.

Control of the navigator 260 rests in the processor 261, which is, for example, a Motorola MC68EZ328. The processor 261 interprets the input from the user controls 264 and sends this information back to the computing platform 100 through the wireless data communication interface 269. The processor 261 also receives and interprets display update information from the audio or video player application 151 running on the computing platform 100 from the wireless data communication interface 269. The display information is sent to the liquid crystal display panel, or LCD, 266, which connects to the navigator 260 circuit board using the connector 688 on the navigator 260. A pair of capacitors 686 and 687 are used to filter power going to the LCD 266 on the connector 688. The processor 261 controls an infrared LED, or IR transmitter, 265 that is used to control audio or video playback devices, such as a stereo or television, that supports infrared control. The transistor 615 acts as a switch based on a signal from the processor 261 to enable and disable the IR transmitter 265. The resistor 617 provides additional load to limit the amount of current to the IR transmitter 265. Another LED 619 indicates to the user that the navigator 260 is successfully powered. A transistor 618 acts as a switch based on a signal from the processor 261 to enable and disable the LED 619 and the resistor 620 provides additional load to limit the amount of current to the LED 619. Oscillator 603 provides timing to the processor 261, while a pair of capacitors 601 and 602 provide loading required by the oscillator 603. The reset signal of the processor 261, which is responsible for resetting the processor 261, is enabled when power is first applied to the processor 261 through a delay circuit composed of a resistor 612 and a capacitor 613. The button 614 also resets the processor 261 and is included for debug purposes. A plurality of capacitors 604, 606, and 607 along with a resistor 605 provide filtering for the power to a phase locked loop, or PLL, circuit within the processor 261 that is used to generate additional timing within the processor 261. A resistor 600 acts as a pull-up to power for a signal on the processor 261.

External random access memory, or RAM, 262, may be provided, configured for example in a 4 megabyte by 16-bit configuration, for storing code other data that doesn't need to survive a power down of the navigator 260. External flash memory 263 may also be provided, for example, in a 1 megabyte by 16-bit configuration, for storing the code to be executed as well as storing data that must survive a power down of the navigator 260. A pair of capacitors 667 and 668 provide filtering for the power to the RAM 262 and flash memory 263.

The user controls 264 may be configured as a set of 16 buttons 669, 670, 671, 672, 674, 675, 676, 677, 678, 679, 680, 681, 682, 683, 684, and 685, arranged in a 4×4 array and scanned by the processor 261. This reduces the number of signals required on the processor 261 to support the user controls 264. A plurality of capacitors 608, 609, 610, and 611 act to reduce voltage spikes on the return signals from the user controls 264 to the processor 261 when the user controls 264 are activated and deactivated.

The button 671 is used to turn power on to the entire navigator 260. The button 671 is always powered, even when power is turned off to the rest of the navigator 260. Diode 673 prevents current leakage from button 671 when the rest of the navigator 260 is turned off. The 3.3-volt regulator 630 provides power to the button 671 as well as a flip-flop 635 that is also always on to receive the power on signal from the button 671. A plurality of capacitors 629, 631, and 632 provide filtering for power to the always on button 671 and flip-flop 635. A pair of resistors 633 and 634 act as pull-ups to power for signals to the flip-flop 635. A resistor 637 and a transistor 636 work together with the flip-flop 635 to control the shut down of the 3.3-volt switcher 640 that provides power to the rest of the navigator 260. A plurality of capacitors 638, 639, 642, and 643 provide filtering for power to and from the switcher 640. An inductor 641 completes a feedback circuit required by the switcher 640. A resistor 645 and a pair of capacitors 644 and 646 provide external compensation circuitry also required by the switcher 640.

A battery 268 provides power to the navigator 260 and connects to the navigator 260 through the connector 590 on the navigator 260. A circuit which includes a plurality of diodes 588, and 589, transistor 585, and a resistors 586 and 587, provides over-voltage protection from the battery 268 and also protect against the battery 268 being plugged incorrectly into the connector 590. This protection can be bypassed by including resistor 584. The navigator 260 supports recharging of the battery 268 through a battery charger 267. The battery charger 267 is composed of a battery charge controller 699, for example, a Maxim Integrated Products MAX712CSE, along with the required support circuitry. The support circuitry required by the battery charge controller 699 diode 689, a transistor 694, a plurality of resistors 691, 693, 696, and 697, and a plurality of capacitors 577, 583, 690, 692, 695, and 698. A plurality of resistors 579, 580 and 582 and a pair of transistors 578 and 581 detect if the battery 268 is rechargeable and provide this signal to the battery charge controller 699 to prevent the battery charger 267 from trying to charge a non-rechargeable battery 268.

An analog to digital converter 599 along with a diode 596, a pair of capacitors 593 and 598, and a plurality of resistors 591, 592, 594, 595, and 597 are used by the processor 261 to monitor the battery voltage level for calculating battery life and controlling battery charging. Using a plurality transistors 650, 653, and 654, a plurality capacitors 649 and 652, and a pair of resistors 651 and 655, the processor 261 can individually control power to the wireless data communication interface 269 and the LCD 266 as part of power management to increase battery life on the navigator 260. In addition, the processor 261 is configured to control the voltage level for the contrast power supplied to the LCD 266, which allows user control of display contrast. To do this, the processor 261 adjusts a digital potentiometer 660, which outputs a variable voltage level based on a voltage divider circuit made up of resistors 658 and 659. This variable voltage level feeds a DC to DC converter 666, which takes this voltage level as an input to determine the contrast supply voltage level that is output to the LCD 266. A resistor 665, an inductor 663, and a diode 662 fulfill the requirements of the DC to DC converter 666. A pair of capacitors 661 and 664 may be used to provide filtering for the contrast power supply to the LCD 266.

A connector 621 may be provided for debug access to the processor 261. The debug port is implemented as an industry standard RS-232 serial port. An RS-232 interface controller 626 handles the required RS232 interface level conversions. A plurality of capacitors 622, 623, 624, 625, and 628 provide filtering for power for the various voltage levels used by the RS-232 interface controller 626. A resistor 627 acts as a pull-up to power for the ON signal to the RS-232 interface controller 626. None of the processor 261 debug port components 621, 622, 623, 624, 625, 626, 627, and 628 are included for production. The flip-flop 657 is unused. A resistor 656 is used to pull-up to power the inputs of the unused flip-flop 657.

Obviously, many modifications and variations of the present invention are possible in light of the above teachings. Thus, it is to be understood that, within the scope of the appended claims, the invention may be practiced otherwise than as specifically described above.

What is claimed and desired to be covered by a Letters Patent is as follows:

We claim:

1. A system for controlling playback of digital content, the system comprising:
a computing platform including playback hardware for converting said digital content to audio signals for playback by an analog playback device;
a digital content player application, resident on said computing platform, for playback of said digital content; and
a remote control device for communicating with said computing platform over a predetermined communication link and controlling said digital content playback application.

2. The system as recited in claim 1, further including a transmitter for transmitting audio signals from said computing platform to a remote analog playback device.

3. The system as recited in claim 1, wherein said digital content is digital audio data.

4. The system as recited in claim 1, wherein said digital data content is digital video data.

5. The system as recited in claim 1, wherein said computing platform includes a local storage device for locally storing digital content.

6. The system as recited in claim 1, wherein said computing platform is configured to receive said digital content over a network.

7. The system as recited in claim 6, wherein said network is the Internet.

8. The system as recited in claim 1, wherein said remote control device includes user inputs as well as user outputs.

9. The system as recited in claim 5, wherein said local storage device includes a persistent storage device.

10. The system as recited in claim 5, wherein said local storage device includes a removable storage device.

11. The system as recited in claim 1, wherein said predetermined communication link is a wireless link.

12. The system as recited in claim 11, wherein said wireless link is an RF link.

13. The system as recited in claim 11, wherein said wireless link is an infrared link.
